(19) United States
(12) Patent Application Publication
(10) Pub. No.: US 2011/0035761 A1
(43) Pub. Date: Feb. 10, 2011

(54) DISK APPARATUS

(75) Inventor: Hitoshi Ueno, Tokorojawa (JP)

Correspondence Address: KRATZ, QUINTOS & HANSON, LLP, 1420 K Street, N.W., 4th Floor, WASHINGTON, DC, 20005, US

(73) Assignee: PIONEER CORPORATION, Kawasaki-shi (JP)

(21) Appl. No.: 12/988,693

(22) PCT Filed: Apr. 23, 2008
(86) PCT No.: PCT/JP2008/057845

§ 371 Date: Oct. 20, 2010

(51) Int. Cl. G11B 17/03

(52) U.S. Cl. 720/601; G9B/17.009

(57) ABSTRACT

The tray of the disc device includes the ground member including the base cover that substantially covers the electronic component and the ground extension portion, and the front projection located forward in the tray-out direction relative to the ground extension portion. The casing includes the casing-side ground contacting portion that contacts the ground extension portion in a tray-in state. In the tray-in state, the ground extension portion and the casing-side ground contacting portion are contacted so that static electricity is flowed to the casing via the ground member, thereby preventing the static electricity from flowing and damaging the electronic component. Even when the ground extension portion is deformed in the tray-out direction, the contact between the ground extension portion and the front projection prevents excessive deformation of the ground extension portion. Thus, the disc device can be easily handled without fearing damage to the ground extension portion.

### TECHNICAL FIELD

The present invention relates to a disc device.

### BACKGROUND ART

There has been conventionally known a disc device applicable to, for instance, a portable personal computer (hereinafter referred to as “laptop”) in which a storage medium is mounted on a tray that can be housed in a casing so that the storage medium is inserted/ejected (e.g., see Patent Literature 1).

The device of Patent Literature 1 is provided with a ground plate being attached to the front end surface of a disc tray. A free end of the ground plate is brought into contact with an opening of a chassis case to establish a discharge path. Thus, when a finger of a user contacts with an operation button, static electricity in the user's body can flow into the discharge path, thereby preventing damage to an electronic component or the like.

[Patent Literature 1] JP-A-2004-152433

### DISCLOSURE OF THE INVENTION

### Problems to Be Solved by the Invention

With the above configuration of Patent Literature 1, a hand can contacts with the free end when a bezel is to be attached to a tray, so that the free end may be deformed in an ejection direction of the tray to be damaged. Accordingly, the device of Patent Document 1 should be used with caution and thus is not easily handled.

An object of the present invention is to provide a disc device that is capable of preventing damage to an electronic component and of being easily handled.

### Means for Solving the Problems

According to an aspect of the invention, a disc device includes: a tray on which a disc storage medium is mounted; and a casing being formed in a substantially box shape of which one surface defines an opening, the casing in which the tray is housed in a movable manner such that the tray is inserted and ejected through the opening, in which the tray is provided with an electronic component being at least partially located at an end in an ejection direction of the tray and a ground member being made of an electrically-conductive material, the ground member being located in a vicinity of the electronic component without connection to the electronic component, the ground member is provided with an electronic component proximal portion being located in the vicinity of the electronic component and a ground extension portion that extends from one end of the electronic component proximal portion in a direction substantially perpendicular to the ejection direction, the tray is provided with a deformation restricting portion being located forward in the ejection direction relative to the ground extension portion, the deformation restricting portion that restricts deformation of the ground extension portion in the ejection direction, and the casing is provided with a casing-side ground contacting portion being made of an electrically-conductive material, the casing-side ground contacting portion being in contact with the ground extension portion when the tray is housed in the casing.

### BRIEF DESCRIPTION OF DRAWINGS

FIG. 1 is a plan view of a disc device according to an exemplary embodiment of the present invention with a tray ejected therefrom, for schematically showing the structure of the tray and an inner structure of a casing.

FIG. 2 is a front view showing the disc device according to the exemplary embodiment with the tray ejected therefrom.

FIG. 3 is a partial cross section, observed from the lower side of the disc device, showing the disc device according to the exemplary embodiment with the tray ejected therefrom.

FIG. 4 is a partial cross section, observed from the lower side of the disc device, showing the disc device according to the exemplary embodiment with the tray housed therein.

FIG. 5 is a partial cross section, observed from the lower side of the disc drive, showing a ground extension portion pressed in an ejection direction of the tray.

### EXPLANATION OF CODES

1 . . . disc device
10 . . . casing
20 . . . tray
21 . . . electronic component
26 . . . ground member
30 . . . disc processor
31 . . . processor cover
117 . . . casing-side ground contacting portion
205 . . . front projection as deformation restricting portion
261 . . . base cover as electronic component proximal portion
264 . . . right fixing portion as ground fixing portion
266 . . . ground-side cover contacting portion
267 . . . ground extension portion

### BEST MODE FOR CARRYING OUT THE INVENTION

An exemplary embodiment of the present invention will be described below with reference to the attached drawings.

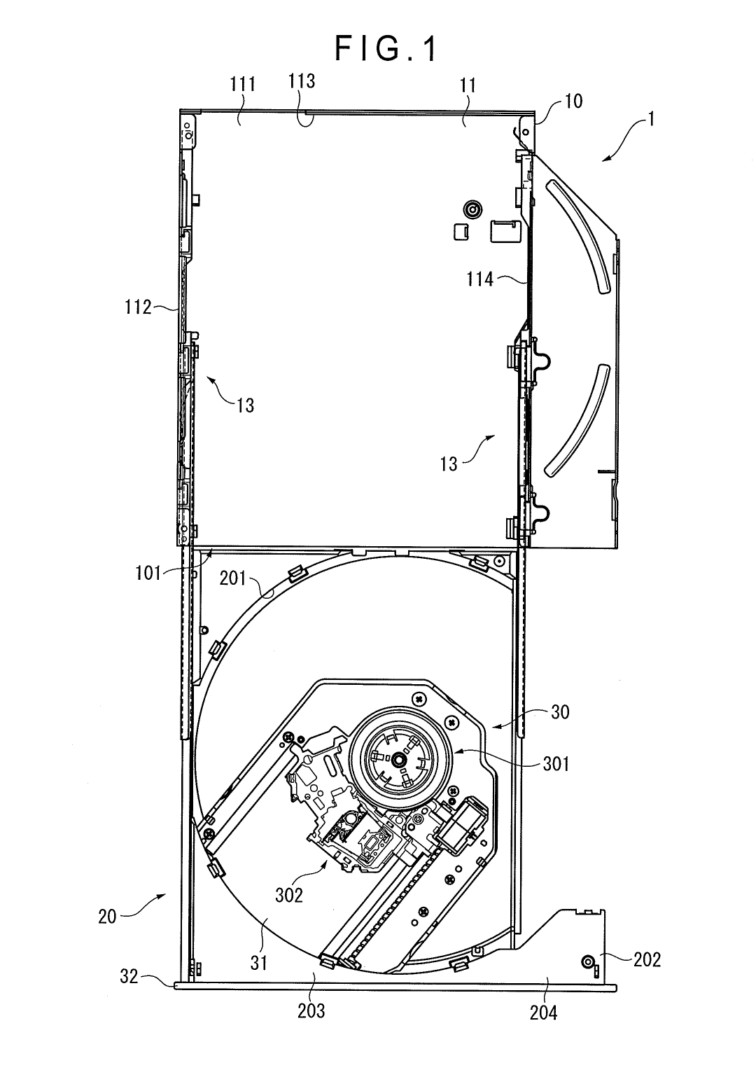

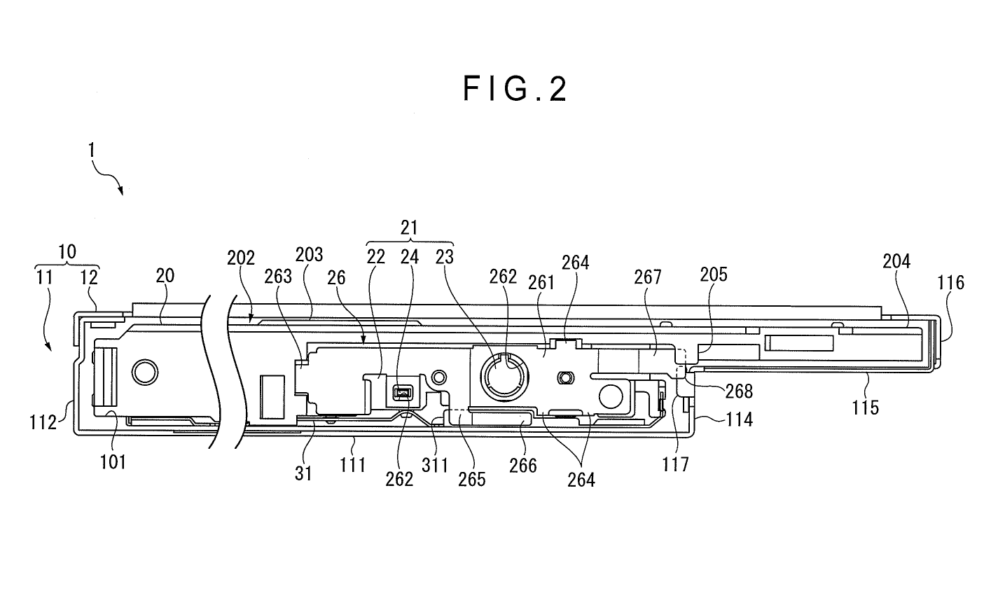

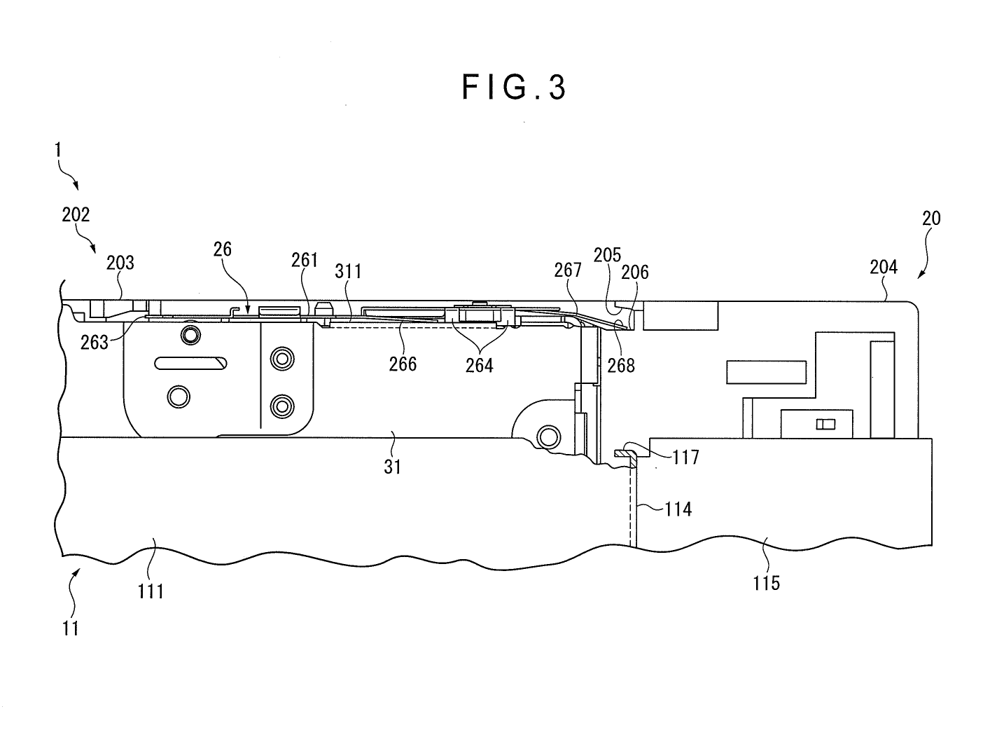

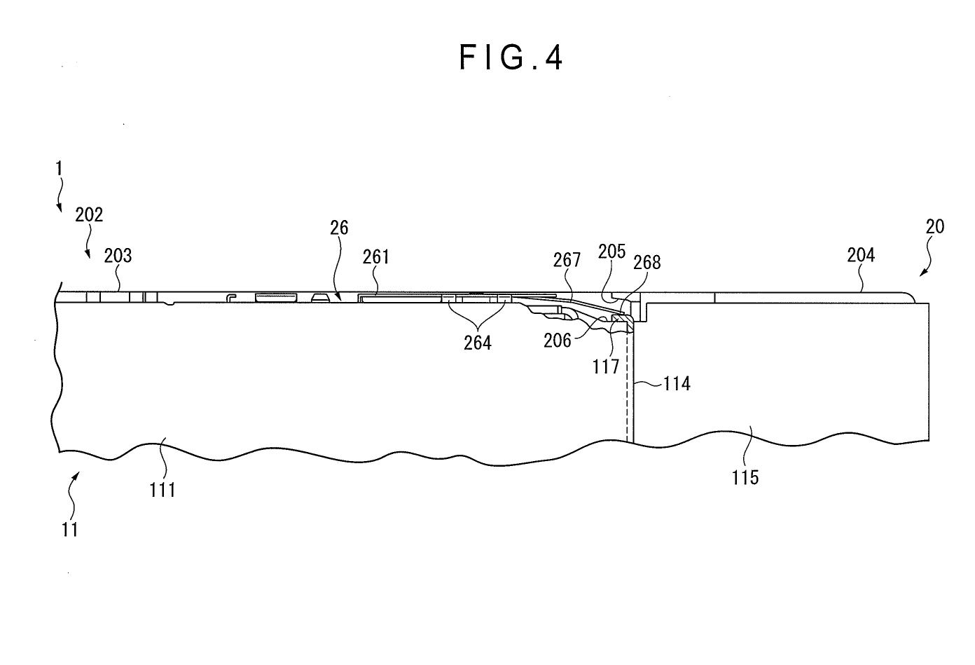

FIG. 1 is a plan view of a disc device with a tray ejected therefrom, for schematically showing the structure of the tray and the inner structure of a casing. FIG. 2 is a front view showing the disc device with the tray ejected therefrom. FIG. 3 is a partial cross section, observed from the lower side of the disc device, showing the disc device with the tray ejected therefrom. FIG. 4 is a partial cross section, observed from the lower side of the disc device, showing the disc device with the tray housed therein.

### Structure of Disc Device

Entire Structure

Description will be first made on the entire structure of a disc device 1.

As shown in FIG. 1, the disc device 1 is a so-called slim-disc device (slim-disc drive) that is mounted on an electronic apparatus such as a portable personal computer (or a “laptop”). The disc device 1 is adapted to execute processing on a removably-mountable disc storage medium such as a CD (Compact Disc), a DVD (Digital Versatile Disc), a BD (Blu-ray Disc) or an HD-DVD (High Definition DVD).

The disc device 1 includes a casing 10.

The casing 10 includes a lower casing 11 located on a bottom side and an upper casing 12 located on a top side (see FIG. 2) and is formed in a substantially box shape defining an inner space.

The casing 10 includes an opening 101 that is defined between the front ends of the lower casing 11 and upper casing 12. The casing 10 is provided with a tray 20 being capable of moving forward and backward through the opening 101. A rail 13 being located along the forward/backward movement direction of the tray 20 and a lock mechanism (not shown) that restricts the forward/backward movement of the tray 20 are provided inside the casing 10.

The tray 20 is formed of, for instance, synthetic resin in a substantially plate shape and is movable forward and backward through the opening 101 of the casing 10. Description will be made below on a state where the tray 20 is housed in the casing 10 (hereinafter referred to as “tray-in state”) and a state where the tray 20 is ejected from the casing 10 (hereinafter referred to as “tray-out state”).

The upper side of the tray 20 is provided with an arc recess 201 being formed slightly larger than the diameter of an optical disc (not shown) as a disc storage medium. The optical disc is mounted on the arc recess 201. The tray 20 is also provided with a disc processor 30 that includes a turntable 301 that holds the optical disc thereon and an information processor 302 that executes processing on the optical disc.

The lower side of the tray 20 is provided with a processor cover 31 so that the disc processor 30 is sandwiched between the tray 20 and the processor cover 31.

A bezel 32 is attached to a front portion 202 of the tray 20 to close the opening 101 in the tray-in state.

Structure of Primary Portion

Description will be made on the structure of a primary portion of the disc device 1.

As shown in FIGS. 1 and 2, the lower casing 11 is made of an electrically-conductive material such as metal. The lower casing 11 includes a bottom portion 111 in the shape of a substantially rectangular plate being longitudinally elongated. A left portion 112, a rear portion 113 and a right portion 114 that extend upward are respectively provided to the left end, rear end and right end of the bottom portion 111. A wing portion 115 that extends rightward is provided to the upper end of the right portion 114. A wing-side portion 116 that extends upward is provided to the right end of the wing portion 115. The upper casing 12 serves as a bridge between the left portion 112 and the wing-side portion 116.

As shown in FIGS. 2 and 3, a casing-side ground contacting portion 117 in the shape of a tongue extending leftward is provided to the front side and upper side of the right portion 114. Being formed by leftwardly cutting and raising a part of the right portion 114, the casing-side ground contacting portion 117 is retracted behind the open surface of the opening 101 (hereinafter referred to as “casing open surface”) toward the rear portion 113 (i.e., in the insertion direction of the tray 20).

The processor cover 31 is formed of an electrically-conductive material such as metal in a plate shape. A cover-side ground contacting portion 311 in the shape of a tongue extending upward is provided to the left side of the front end of the processor cover 31.

The front portion 202 of the tray 20 includes a substantially rectangular base 203 and a right projection 204 that projects in a substantially rectangular shape from the right end of the base 203.

A front projection 205 in the shape of a tongue extending downward as the deformation restricting portion is provided to the front end of the right projection 204 near the base 203. The front projection 205 is located on the upper front side of the casing-side ground contacting portion 117. A rear projection 206 being substantially parallel with the front projection 205 is provided to the rear side of the front projection 205. As shown in FIG. 4, the rear projection 206 is positioned behind the casing-side ground contacting portion 117 in the tray-in state.

As shown in FIG. 2, an electronic component 21 is visibly located behind the base 203 at the side of the right projection 204. In other words, the electronic component 21 is located at an end in a direction where the tray 20 is ejected (hereinafter referred to as “tray-out direction”). The electronic component 21 includes a circuit board 22 and a switch section 23 and an LED 24 that are provided to the circuit board 22. The switch section 23 is pressed down using a button (not shown) on the bezel 32. When the switch section 23 is pressed down, a tray ejecting mechanism (not shown) is driven to eject the tray 20. The LED 24 lights up depending on the drive state of the disc device 1.

A substantially plate-shaped ground member 26 made of an electrically-conductive material such as metal is provided to the base 203. The ground member 26 is located in the vicinity of the electronic component 21 without connection to the electronic component 21. The ground member 26 includes a base cover 261 in the shape of a substantially laterally-elongated rectangle as the electronic component proximal portion. The base cover 261 is located in the vicinity of the electronic component 21 to substantially cover the electronic component 21. The base cover 261 is provided with an exposing hole 262 through which the switch section 23 and the LED 24 are visible.

The left fixing portion 263 being fixed to the base 203 is provided on the left end of the base cover 261. A right fixing portion 264 as the ground fixing portion being fixed to the base 203 is provided to each of the upper and lower ends of the right side of the base cover 261.

A ground-side cover contacting portion 266 is provided via a joint 265 to a substantially lateral center of the lower end of the base 261 at the left side of the right fixing portion 264. The ground-side cover contacting portion 266 is formed in the shape of a tongue extending leftward and is constantly in contact with the cover-side ground contacting portion 311 of the processor cover 31. The ground-side cover contacting portion 266 and the cover-side ground contacting portion 311 are contacted to define a first discharge path in the tray-out state shown in FIG. 3 and in the tray-in state shown in FIG. 4.

With the first discharge path, when the finger of a user is close to the button of the bezel 32, static electricity charged in the user can flow to the processor cover 31 via the ground member 26, thereby preventing the static electricity from flowing to the electronic component 21. Thus, it is possible to prevent damage to the electronic component 21 in the tray-out state and in the tray-in state.

The right end of the base cover 261 is provided with a ground extension portion 267 in the shape of a tongue extending rightward (i.e., in a direction substantially perpendicular to the tray-out direction). The ground extension portion 267 is longitudinally deformable and has a tip end 268 that, when the ground extension portion 267 is deformed, moves along a movement path on which the front projection 205, the casing-side ground contacting portion 117 and the rear projection 206 exist. The ground extension portion 267 can be bent backward at two bendable parts aligned in its extending direction. The tip end 268 is thus brought into contact with the rear projection 206 in the tray-out state as shown in FIG. 3. In other words, the front projection 205 is located at the front side (forward in the tray-out direction) relative to the ground extension portion 267.

In the tray-in state as shown in FIG. 4, the ground extension portion 267 is in contact with the casing-side ground contacting portion 117 of the casing 10 to form a second discharge path. In the formation of the second discharge path, when the tip end 268 is in contact with the casing-side ground contacting portion 117, the ground extension portion 267 is biased and deformed in a casing ejection direction. The reaction force of this deformation serves to press the tip end 268 against the casing-side ground contacting portion 117. Thus, even when the disc device 1 is slightly vibrated, the tip end 268 and the casing-side ground contacting portion 117 are prevented from separating from each other, thereby securing the second discharge path.

With the second discharge path, when a finger of a user is close to the button of the bezel 32, static electricity charged in the user can flow to the lower casing 11 of the casing 10 via the ground member 26, thereby preventing the static electricity from flowing to the electronic component 21. Thus, it is possible to prevent damage to the electronic component 21 in the tray-in state.

### Operation of Disc Device

Description will be made on an operation of the disc device 1 when the ground extension portion 267 is pressed in the tray-out direction.

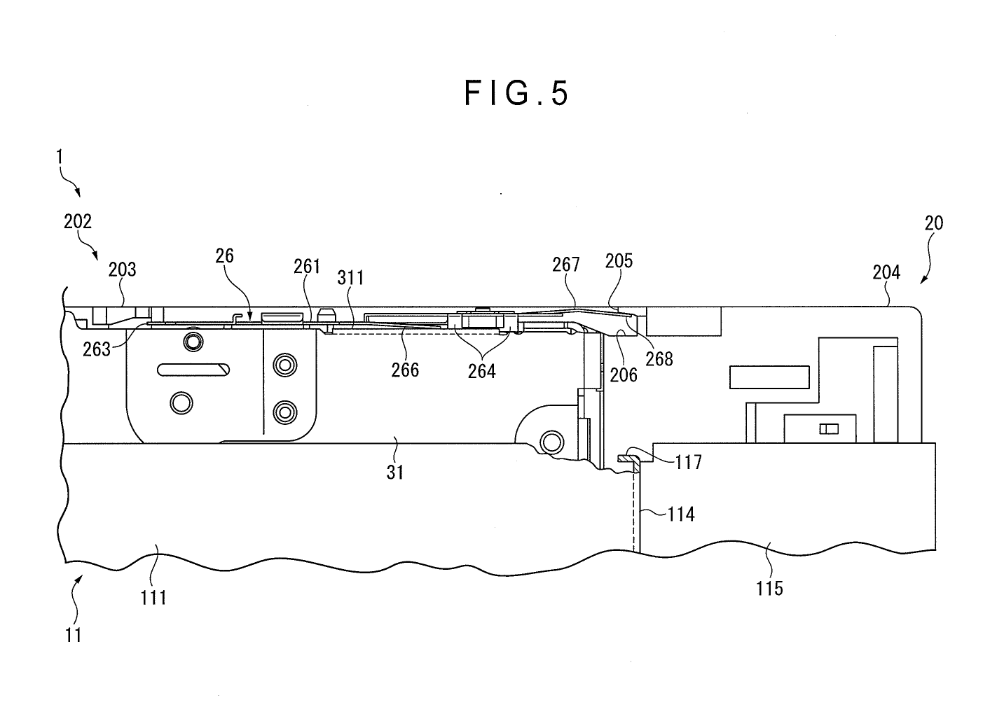

FIG. 5 is a partial cross section observed from the lower side of the disc drive, for showing the ground extension portion pressed in the tray-out direction.

When a finger contacts with the ground extension portion 267 to hold the disc device 1, for instance, in order to attach the bezel 32, and the ground extension portion 267 is thus deformed in the tray-out direction as shown in FIG. 5, the tip end 268 is brought into contact with the front projection 205 of the tray 20 located on its movement path. The contact between the tip end 268 and the front projection 205 prevents the ground extension portion 267 from being excessively deformed.

### [Advantages of Disc Device]

As described above, the above exemplary embodiment can attain the following advantages.

(1) The tray 20 of the disc device 1 is provided with the ground member 26 including the base cover 261 that substantially covers the electronic component 21 and the ground extension portion 267 that extends rightward from the base cover 261, and the front projection 205 being located forward in the tray-out direction relative to the ground extension portion 267. The casing 10 is provided with the casing-side ground contacting portion 117 that is in contact with the ground extension portion 267 in the tray-in state.

With this arrangement, in the tray-in state, the ground extension portion 267 and the casing-side ground contacting portion 117 are brought into contact with each other to enable static electricity charged in a user to flow to the casing 10 via the ground member 26, thereby preventing the static electricity from flowing to the electronic component 21 to damage the electronic component 21. In addition, even when the ground extension portion 267 is deformed in the tray-out direction because of the contact with a finger, the contact between the ground extension portion 267 and the front projection 205 prevents the ground extension portion 267 from being excessively deformed. Therefore, the disc device 1 can be easily handled without worrying about damage to the ground extension portion 267.

(2) The casing-side ground contacting portion 117 is retracted behind the casing open surface toward the rear portion 113.

If the casing-side ground contacting portion 117 is located on the same plane as the casing open surface or is located outside the casing open surface, the tip end 268 would be positioned outside the casing open surface when the tray 20 is housed in the casing 10 and the ground extension portion 267 and the casing-side ground contacting portion 117 are contacted with each other. Thus, the front projection 205 would be necessarily located more outside than such a contact section, which results in increase in the longitudinal size of the disc device 1.

Conversely, in the exemplary embodiment, since the casing-side ground contacting portion 117 is retracted from the casing open surface toward the rear portion 113, the front projection 205 can be located substantially on the same plane as the casing open surface, thereby suppressing increase in the longitudinal size of the disc device 1.

(3) The casing-side ground contacting portion 117 is formed by cutting and raising a part of the right portion 114.

Thus, since it is not required to attach the casing-side ground contacting portion 117 to the lower case 11, or the like, productivity of the disc device 1 can be improved. In addition, the number of the components of the disc device 1 can be reduced.

(4) The right fixing portions 264 are provided to the right side of the base cover 261 in the vicinity of the proximal end of the ground extension portion 267 in order to fix the ground member 26 to the base 203 of the tray 20. In addition, the ground-side cover contacting portion 266 that is in contact with the processor cover 31 via the cover-side ground contacting portion 311 is provided to the left side of the right fixing portions 264 (i.e., to the opposite side of the ground extension portion 267 relative to the right fixing portions 264).

If the ground-side cover contacting portion 266 is provided to the same side as the ground extension portion 267 relative to the right fixing portions 264, the ground-side cover contacting portion 266 would separate from the processor cover 31 when the ground extension portion 267 is deformed in the tray-out direction, so that the first discharge path may not be secured. In order to reliably secure the first discharge path, fixation of the ground-side cover contacting portion 266 to the processor cover 31 would be required, which may result in increase in the steps of a manufacturing process.

Conversely, in the exemplary embodiment, since the ground-side cover contacting portion 266 is provided on the opposite side of the ground extension portion 267 relative to the right fixing portions 264, even when the ground extension portion 267 is deformed in the tray-out direction, the ground-side cover contacting portion 266 is prevented from separating from the processor cover 31. Therefore, the first discharge path can be secured without fixing the ground-side cover contacting portion 266 to the processor cover 31, thereby preventing increase in the steps of the manufacturing process.

### Modifications of Exemplary Embodiment

It should be noted that the present invention is not limited to the exemplary embodiment described above, but may include modifications described below within a scope where an object of the present invention can be achieved.

Specifically, the front projection 205 may be located at an outside position relative to that of the exemplary embodiment while the casing-side ground contacting portion 117 is located on the same plane as the casing open surface or located outside the casing open surface. An example of the arrangement where the casing-side ground contacting portion 117 is substantially coplanar with the casing open surface is that the right portion 114 is not cut and raised so that the end of the right portion 114 functions as the casing-side ground contacting portion 117.

Alternatively, the casing-side ground contacting portion 117 may be formed by cutting and raising a part of the bottom portion 111 of the lower case 11.

Furthermore, the casing-side ground contacting portion 117 and the lower case 11 are separately formed and are fixed to each other by screwing, latching, fitting, crimping, bonding or the like. In this arrangement, the lower casing 111 may be made of a material without electrical conductivity while the casing-side ground contacting portion 117 is made of an electrically-conductive material.

The ground-side cover contacting portion 266 may be located on the same side as the ground extension portion 267 relative to the right fixing portions 264.

Specific configurations and processes when implementing the present invention may be other configurations or the like as long as an object of the present invention can be attained.

### Advantages of Embodiment

In the exemplary embodiment, as described above, the tray 20 of the disc device 1 is provided with the ground member 26 including the base cover 261 that substantially covers the electronic component 21 and the ground extension portion 267, and the front projection 205 being located forward in the tray-out direction relative to the ground extension portion 267. The casing 10 is provided with the casing-side ground contacting portion 117 that is in contact with the ground extension portion 267 in the tray-in state.

With this arrangement, in the tray-in state, the ground extension portion 267 and the casing-side ground contacting portion 117 are brought into contact with each other to enable static electricity charged in a user to flow to the casing 10 via the ground member 26, thereby preventing the static electricity from flowing to the electronic component 21 to damage the electronic component 21. In addition, even when the ground extension portion 267 is deformed in the tray-out direction, the contact between the ground extension portion 267 and the front projection 205 prevents the ground extension portion 267 from being excessively deformed. Therefore, the disc device 1 can be easily handled without worrying about damage to the ground extension portion 267.

### INDUSTRIAL APPLICABILITY

The present invention is applicable as a disc device.

1. A disc device comprising:
a tray on which a disc storage medium is mounted; and
a casing being formed in a substantially box shape of which one surface defines an opening, the casing in which the tray is housed in a movable manner such that the tray is inserted and ejected through the opening, wherein
the tray is provided with an electronic component being at least partially located at an end in an ejection direction of the tray and a ground member being made of an electrically-conductive material, the ground member being located in a vicinity of the electronic component without connection to the electronic component,
the ground member is provided with an electronic component proximal portion being located in the vicinity of the electronic component and a ground extension portion that extends from one end of the electronic component proximal portion in a direction substantially perpendicular to the ejection direction,
the tray is provided with a deformation restricting portion being located forward in the ejection direction relative to the ground extension portion, the deformation restricting portion that restricts deformation of the ground extension portion in the ejection direction, and
the casing is provided with a casing-side ground contacting portion being made of an electrically-conductive material, the casing-side ground contacting portion being in contact with the ground extension portion when the tray is housed in the casing.

2. The disc device according to claim 1, wherein
the casing-side ground contacting portion is located forward in an insertion direction of the tray relative to an open surface of the casing.

3. The disc device according to claim 2, wherein
the casing is formed of an electrically-conductive material in the substantially box shape, and
the casing-side ground contacting portion is formed by cutting and raising a part of an open end of the casing in a direction intersecting the ejection direction to be located forward in the insertion direction relative to the open surface.

4. The disc device according to claim 1, wherein
the tray is provided with a disc processor that executes processing on the disc storage medium and a processor cover being made of an electrically-conductive material, the processor cover that holds the disc processor against the tray,
the electronic component proximal portion of the ground member is provided with a ground fixing portion being fixed to the tray and a ground-side cover contacting portion being in contact with the processor cover, and
the ground-side cover contacting portion is located at a side opposite to the ground extension portion relative to the ground fixing portion.

5. The disc device according to claim 2, wherein
the tray is provided with a disc processor that executes processing on the disc storage medium and a processor cover being made of an electrically-conductive material, the processor cover that holds the disc processor against the tray,
the electronic component proximal portion of the ground member is provided with a ground fixing portion being fixed to the tray and a ground-side cover contacting portion being in contact with the processor cover, and
the ground-side cover contacting portion is located at a side opposite to the ground extension portion relative to the ground fixing portion.

6. The disc device according to claim 3, wherein
the tray is provided with a disc processor that executes processing on the disc storage medium and a processor cover being made of an electrically-conductive material, the processor cover that holds the disc processor against the tray,
the electronic component proximal portion of the ground member is provided with a ground fixing portion being fixed to the tray and a ground-side cover contacting portion being in contact with the processor cover, and
the ground-side cover contacting portion is located at a side opposite to the ground extension portion relative to the ground fixing portion.
